(19) United States
(12) Patent Application Publication
(10) Pub. No.: US 2004/0247997 A1
(43) Pub. Date: Dec. 9, 2004

(54) Battery storage apparatus

(76) Inventor: Liang-Yi Lu, Taipei (TW)

Correspondence Address: Pepper Hamilton LLP, One Mellon Center, 50th Floor, 500 Grant Street, Pittsburgh, PA, 15219, US

(21) Appl. No.: 10/457,245

(22) Filed: Jun. 9, 2003

(51) Int. Cl. H01M 2/10

(52) U.S. Cl. 429/97; 429/100

(57) ABSTRACT

A battery storage apparatus built in a Notebook PC is employed to store a removable battery. The battery storage apparatus has an upper cover and a lower cover. The battery storage apparatus has several support pins around the opening. The battery storage apparatus further has a side cover attached to the removable battery. The support pins prevent the side cover from sticking in the battery storage apparatus.

### BACKGROUND OF THE INVENTION

1. Field of Invention

The present invention relates to a battery storage apparatus. More particularly, the present invention relates to a battery storage apparatus in a notebook PC.

2. Description of Related Art

As computer manufacturing techniques advance rapidly, desktop computer calculation speed is increasing as the body thereof is becoming lighter and thinner. Moreover, notebook PCs enable users to work anywhere.

A battery is essential to supply a portable notebook PC's power. The capacity and weight of a battery are critical factors for the portable notebook PC. Because current battery capacity usually supplies a notebook PC two or three hour operation time, the battery module is designed to be replaceable, with an expended battery being replaced with a backup battery. FIG. 1 illustrates possible drawbacks of a conventional battery storage apparatus in a notebook PC. When a battery 12 is inserted into a notebook PC 10, a side cover of said battery 12 often sticks in an opening 16 of a conventional battery storage apparatus.

### SUMMARY OF THE INVENTION

It is therefore an objective of the present invention to provide a battery storage apparatus in a notebook PC so as to prevent the removable battery from sticking in the battery storage apparatus.

In accordance with the foregoing and other objectives of the present invention, a battery storage apparatus built in a Notebook PC is employed to store a removable battery. The battery storage apparatus consists of an upper cover and a lower cover. The battery storage apparatus' feature lies in several support pins around the opening. The battery storage apparatus further comprises a side cover attached to the removable battery, where the support pins prevent the side cover from sticking in the battery storage apparatus.

According to one preferred embodiment of present invention, the support pins around the opening can be ribs or cylindrical pins. The lower cover further includes a net-like structure for reinforcement and to support more weight. The side cover further includes a holder for manual pulling.

As embodied and broadly described herein, the invention provides several support pins around the opening of the battery storage apparatus. Thus, the battery does not easily stick in the opening when the battery is inserted into the battery storage apparatus.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates possible drawbacks of a conventional battery storage apparatus in a notebook PC;

FIG. 2 illustrates a perspective view of a battery storage apparatus according to one preferred embodiment of this invention;

FIG. 3 illustrates a detailed inner view of a battery storage apparatus according to one preferred embodiment of this invention; and

FIGS. 4A, 4B, 4C respectively illustrate a front view, a side view, and a cross-sectional view of a battery storage apparatus according to one preferred embodiment of this invention.

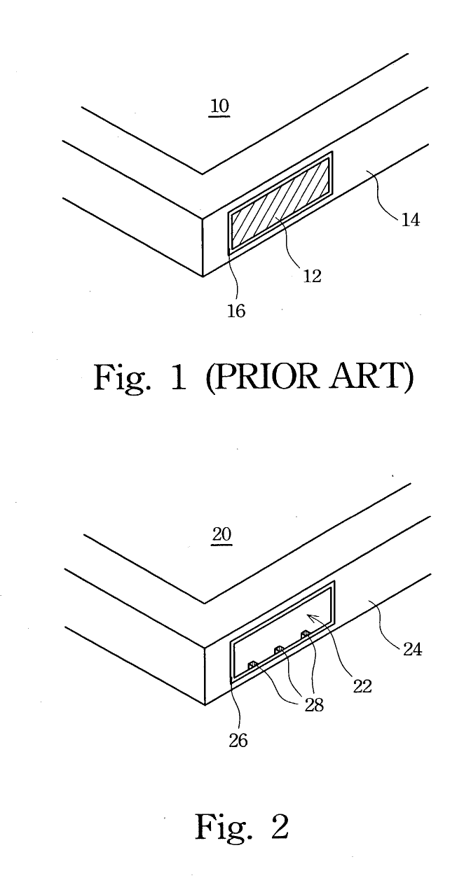

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 illustrates a perspective view of a battery storage apparatus according to one preferred embodiment of this invention. There is an opening 22 for replacing the removable battery on one side of outer housing 24 of a notebook PC 20. In one preferred embodiment of present invention, several support pins 28 are designed in an area 26 surrounding the opening 22. The main function of support pins 28 is to support a side cover of the removable battery if the side cover is pushed inside and beyond the outer housing 24. Thus, the support pins 28 can prevent the side cover of the removable battery from sticking in the opening 22. The number of support pins 28 can vary in accordance with the battery weight. Moreover, the positions of the support pins 28 are not limited to the lower area surrounding the opening 26. The support pins 28 can be ribs or cylindrical pins.

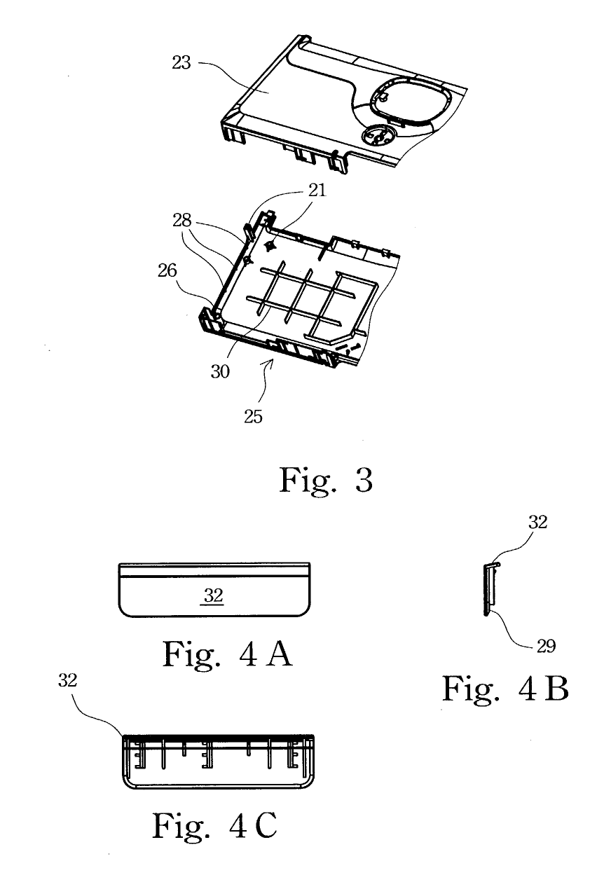

FIG. 3 illustrates an inner detailed view of a battery storage apparatus according to one preferred embodiment of this invention. In one preferred embodiment of present invention, the battery storage apparatus consists of an upper cover 23 and a lower cover 25. The lower cover 25 includes a net-like structure 30 for reinforcement and to support the removable battery.

FIGS. 4A, 4B, 4C respectively illustrate a front view, a side view, and a cross-sectional view of a battery storage apparatus according to one preferred embodiment of this invention. The side cover 32 is attached to the removable battery. The shape of the side cover 32 is designed to fit the opening 22. Referring to FIG. 4B, the side cover 32 includes a holder 29 for manual pulling

In accordance with a preferred embodiment of present invention, several support pins are designed around the opening of the battery storage apparatus. Therefore, the removable battery does not easily stick in the opening when the removable battery is inserted into the battery storage apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A battery storage apparatus employed to keep a removable battery in a notebook PC, said battery storage apparatus comprising:
an upper cover;
a lower cover;
an opening, defined by said upper cover and said lower cover, an area of said upper cover and said lower cover surrounding said opening, and a plurality of support pins being located in said area; and
a side cover, attached to said removable battery, wherein said plurality of support pins prevents said side cover from sticking in said opening when said removable battery is inserted into said battery storage apparatus.

2. The battery storage apparatus of claim 1, wherein said support pins are ribs or cylindrical pins.

3. The battery storage apparatus of claim 1, wherein said lower cover further comprises a net-like structure.

4. The battery storage apparatus of claim 1, wherein said side cover further comprises a holder.

5. A battery storage apparatus employed to keep a removable battery in a notebook PC, said battery storage apparatus comprising:
an opening, defined by said upper cover and said lower cover, an area surrounding said opening having a plurality of support pins; and
a side cover, attached to said removable battery, wherein said plurality of support pins prevent said side cover from being stuck in said opening if said removable battery is inserted into said battery storage apparatus.

6. The battery storage apparatus of claim 5, wherein said support pins are ribs or cylindrical pins.

7. The battery storage apparatus of claim 5, wherein said side cover further comprises a holder.
